(19) United States
(12) Patent Application Publication
(10) Pub. No.: US 2009/0147311 A1
(43) Pub. Date: Jun. 11, 2009

(54) Image Processing Device, Image Forming Apparatus, and Image Forming Method

(75) Inventors: Koji YANAGISAWA, Shiojiri-shi (JP); Mitsukazu KUROSE, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/329,256

(22) Filed: Dec. 5, 2008

(30) Foreign Application Priority Data
Dec. 6, 2007 (JP) 2007-315444
Sep. 3, 2008 (JP) 2008-225539

(51) Int. Cl. H04N 1/00

(52) U.S. Cl. 358/1.16

(57) ABSTRACT

An image processing device includes: a first memory unit which receives screen data selected from a plurality of screen data stored in a second memory unit and transferred to the first memory unit, and stores the received screen data; and a third memory unit which has a first area for receiving first line data as line unit data of screen data stored in the first memory unit and transferred to the first area and for storing the first line data, and a second area for receiving second line data as line unit data of the screen data stored in the first memory unit and transferred to the second area and for storing the second line data.

### BACKGROUND

1. Technical Field

The present invention relates to an image processing device, an image forming apparatus, and image forming method capable of efficiently performing screen processing while maintaining low cost.

2. Related Art

According to screen processing performed by an image forming apparatus such as printer, a method which switches screens according to printing modes such as image mode and text mode is known. In the screen processing of the printer, a lookup table (LUT) is provided in an internal memory of an image processing board (printer controller), and screen processing is performed while reading table values from the internal memory in a method known in the art. According to a screen processing method disclosed in JP-A-2002-369001, for example, a table (N×N pixel index table, gamma-cell table) necessary for the screen processing is stored in the internal memory, and output signals (laser pulse signals) are produced based on input images and table values.

According to a system which performs screen processing by the method disclosed in JP-A-2002-369001 using hardware logic circuit, the necessary internal memory capacity increases as the screen table (screen data) becomes larger. In this case, the cost of the system rises. Moreover, the screen processing is conducted after all the table values are read from the internal memory at a time. Thus, long time is required and the screen processing cannot be performed with high efficiency. Furthermore, according to the system which carries out screen processing by the hardware logic circuit described in JP-A-2002-369001, the screen type and table size differ according to the sheet type, attributes of print image data, gradation values of print image data, and other conditions. Thus, the internal memory capacity of the printer sufficient for containing different screen tables increases, and the cost of the system rises.

### SUMMARY

It is an advantage of some aspects of the invention to provide an image processing device, an image forming apparatus, and an image forming method capable of efficiently performing screen processing while suppressing increase in the cost of the internal memory.

An image processing device according to a first aspect of the invention includes: a first memory unit which receives screen data selected from a plurality of screen data stored in a second memory unit and transferred to the first memory unit, and stores the received screen data; and a third memory unit which has a first area for receiving first line data as line unit data of screen data stored in the first memory unit and transferred to the first area and for storing the first line data, and a second area for receiving second line data as line unit data of the screen data stored in the first memory unit and for storing the second line data.

It is preferable to further include: a screen processing unit which reads the first line data or the second line data stored in the third memory unit and performs screen processing for print image data based on the line data thus read out; and a reference signal producing unit which produces a reference signal based on which third line data as line unit of the screen data stored in the first memory unit is written to the third memory unit in synchronization with reading of the first line data or the second line data in the image processing device.

An image forming method according to a second aspect of the invention includes: transferring first screen data selected according to types of transfer medium inputted by a transfer medium information input unit from a second memory unit which stores a plurality of screen data to a first memory unit, and storing the selected first screen data; transferring first line data as line image unit of the first screen data stored in the first memory unit to a first area of a third memory unit and storing the transferred first line data in the first area, and transferring second line data as line image unit of the first screen data stored in the first memory unit to a second area of a third memory unit and storing the transferred second line data in the second area; and reading the first line data to perform screen processing for print image data.

It is preferable to further include: reading the first line data to perform screen processing for print image data, and then reading the second line data to perform screen processing; and writing third line data as line image unit of the screen data stored in the first memory unit to the third memory unit based on a reference signal produced in synchronization with reading of the second line data in the image forming method.

It is preferable to further include: a rotational image carrying body; an exposure head which includes an image forming system having negative optical power and light emission elements forming an image by using the image forming system and disposed in the rotational axis direction and rotational direction of the image carrying body; and switching arrangement of image data to which screen processing has been applied based on the screen data in the rotational axis direction and rotation direction of the image carrying body after reading the first line data and performing screen processing for print image data in the image forming method.

An image forming apparatus according to a third aspect of the invention includes: a rotational image carrying body; an exposure head which includes an image forming system having negative optical power and light emission elements forming an image by using the image forming system and disposed in the rotational axis direction and rotational direction of the image carrying body; a first memory unit which stores screen data; a screen processing unit which performs screen processing based on the screen data stored in the first memory unit; and a control unit which switches arrangement of image data to which screen processing has been applied based on the screen data stored in the first memory unit in the rotational axis direction and rotation direction of the image carrying body.

It is preferable to further include: a developing unit which develops a latent image formed on the image carrying body by using the exposure head; a transfer material to which the image developed on the image carrying body by the developing unit is transferred; a transfer unit which transfers the image transferred on the transfer material to a recording medium; and a recording medium information input unit which inputs information on the recording medium transferred by the transfer unit in the image forming apparatus.

It is preferable to further comprising a second memory unit which stores first screen data associated with the type of the recording medium inputted to the recording medium information input unit in the image forming apparatus. In this case, second screen data stored in the second memory unit is transferred to the first memory unit to be stored therein, and the screen processing unit performs screen processing based on the first screen data stored in the first memory unit.

It is preferable to further include a third memory unit which writes line data as line image unit of the screen data stored in the first memory unit and reads the written line data in the image forming apparatus.

It is preferable to further include: a first area to which first line data of the screen table is written; and a second area to which second line data of the screen table is written. In this case, the screen processing unit performs screen processing while reading the line data written to the first area, and a reference signal producing unit produces a reference signal based on which third line data is written to the second area of the third memory unit in synchronization with the reading performed by the screen processing unit in the image forming apparatus.

It is preferable that the second memory unit has a plurality of screen data according to types of recording medium in the image forming apparatus.

It is preferable that the second memory unit has a plurality of screen data according to inputted attributes of print image data in the image forming apparatus.

It is preferable that the second memory unit has a plurality of screen data corresponding to gradation values of inputted print image data in the image forming apparatus.

It is preferable that the screen data stored in the second memory unit is selected according to information about recording medium inputted to the recording medium information input unit, attributes of the inputted print image data, and gradation values of the inputted print image data. Then, the selected screen data is transferred to the first memory unit.

### BRIEF DESCRIPTION OF THE DRAWINGS

The invention will be described with reference to the accompanying drawings, wherein like numbers reference like elements.

FIG. 1 is a block diagram showing an embodiment of the invention.

FIG. 2 is a block diagram showing an embodiment of the invention.

FIG. 3 is a block diagram showing an embodiment of the invention.

FIG. 4 is a block diagram showing the embodiment of the invention.

FIGS. 5A and 5B are views for explaining the embodiment of the invention.

FIG. 6 is a view for explaining the embodiment of the invention.

FIGS. 7A through 7C are views for explaining the embodiment of the invention.

FIG. 8 is a view for explaining the embodiment of the invention.

FIG. 9 is a flowchart according to the embodiment of the invention.

FIGS. 10A through 10D are views for explaining the embodiment of the invention.

FIG. 11 is a view for explaining the embodiment of the invention.

FIG. 12 is a view for explaining the embodiment of the invention.

FIG. 13 is a flowchart showing the embodiment of the invention.

FIG. 14 is a flowchart showing the embodiment of the invention.

FIG. 15 is a flowchart showing the embodiment of the invention.

FIG. 16 is a flowchart showing the embodiment of the invention.

FIG. 17 is a flowchart showing the embodiment of the invention.

FIG. 18 is a flowchart showing the embodiment of the invention.

FIG. 19 is a flowchart showing the embodiment of the invention.

FIG. 20 is a flowchart showing the embodiment of the invention.

FIG. 21 is a block diagram showing an embodiment of the invention.

FIG. 22 is a block diagram showing the embodiment of the invention.

FIG. 23 is a block diagram showing the embodiment of the invention.

FIG. 24 is a block diagram showing the embodiment of the invention.

FIG. 25 is a block diagram showing the embodiment of the invention.

FIG. 26 is a view for explaining an embodiment of the invention.

FIG. 27 is a view for explaining an embodiment of the invention.

FIG. 28 is a view for explaining an embodiment of the invention.

FIG. 29 is a view for explaining an embodiment of the invention.

FIGS. 30A through 30C are views for explaining the embodiment of the invention.

FIG. 31 is a view for explaining the embodiment of the invention.

FIG. 32 is a vertical cross-sectional side view of an image forming apparatus according to the embodiment of the invention.

FIG. 33 is a view for explaining a structure in related art.

FIG. 34 is a view for explaining the embodiment of the invention.

### DESCRIPTION OF EXEMPLARY EMBODIMENTS

Exemplary embodiments according to the invention are hereinafter described with reference to the drawings.

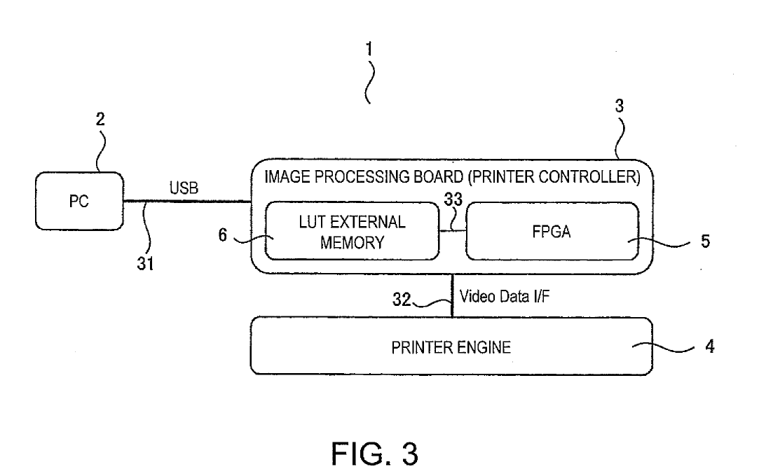

FIG. 3 is a block diagram showing the embodiment of the invention. As shown in FIG. 3, an image forming apparatus 1 includes an image forming unit 2, an image processing board (printer controller) 3, and a printer engine 4. The image forming unit 2 is constituted by an RIP (raster image processor) server of a personal computer (PC).

The image processing board 3 is an H/W board connected with the PC via a USB cable 31, and an FPGA (field programmable gate array) 5 provided on the board performs image processing of color conversion process and screen process in this order. The image processing board 3 is connected with a printer engine 4 via a video interface (video I/F) 32.

An LUT external memory 6 is provided outside the FPGA 5, and connected with the FPGA 5 via a signal line 33. The LUT external memory 6 uses large-capacity memory such as DDR2 SDRAM.

According to a structure in related art, memory for screen table (screen data, screen data is referred to as screen table as well in this embodiment) is difficult to be provided inside the FPGA. In this embodiment, however, the screen table containing a large number of pixels can be mounted on the image processing board 3 by providing the large-capacity memory outside the FPGA. According to this embodiment, therefore, the FPGA 5 (image processing unit) and the LUT external memory 6 are mounted at different positions on the image processing board 3.

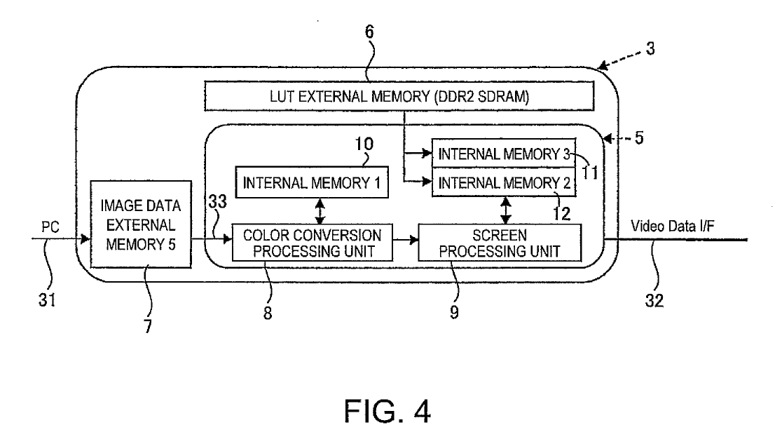

FIG. 4 is a block diagram showing the details of the image processing board 3. The image processing board 3 has the LUT external memory 6, and a print image data (hereinafter abbreviated as image data as well in this embodiment) external memory 7. The FPGA 5 has a color conversion processing unit 8, a screen processing unit 9, and internal memories 10 through 12. The print image data read from the PC is temporarily stored in the image data external memory 7.

The FPGA 5 provided on the image processing board 3 performs pipe-line image processing conducting color conversion process and screen process in this order in synchronization with requirement from a printer engine, and the processed data is transferred to the printer engine. The screen processing internal memories 11 and 12 are updated in synchronization with requirement from the printer engine while the screen processing is being performed. It is possible to use the same external memory for the image data external memory 7 and the LUT external memory 6.

For processing the respective images, values in the table (LUT) stored in the internal memory of the FPGA are referred to during the image processing. Possible printing environment includes environment where printing is performed from a client PC connected with the server PC via network or the like, and environment where printing is performed from the server PC. When printing is conducted by application installed in the client PC or server PC, page description language (PDL; such as post script) is transmitted. Then, the server PC analyzes the PDL and carries out printing.

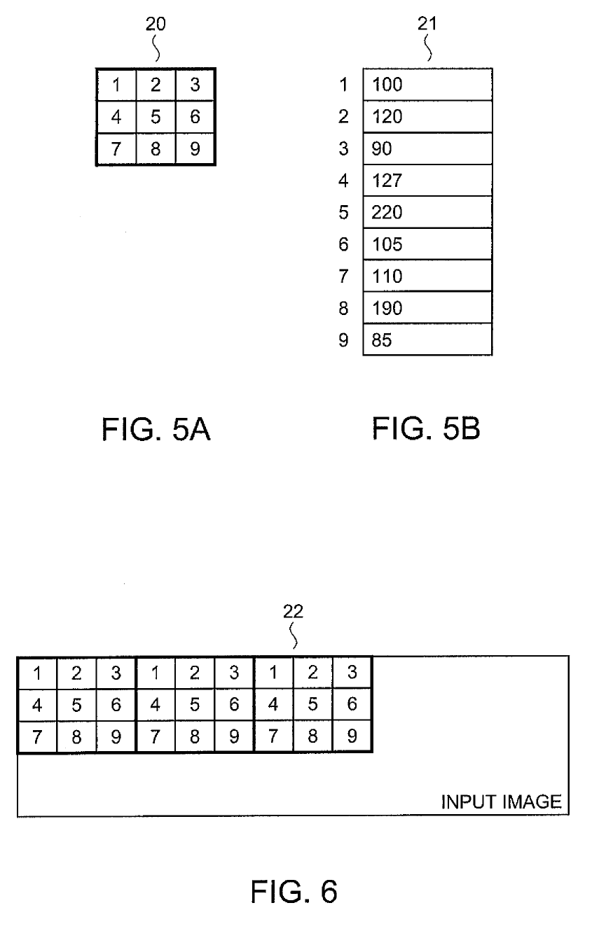

FIGS. 5A and 5B are views for explaining this embodiment. FIG. 5A shows a structure of a screen 20. The screen 20 contains (3×3) elements, and numbers 1 to 9 are given to the respective elements for easy understanding. FIG. 5B illustrates a structure of a memory 21. The memory 21 stores thresholds (100 through 85) corresponding to the elements 1 through 9 of each screen by LUT values.

FIG. 6 shows an example which allocates the screens to an input image 22. The respective gradation values of the input image 22 and the threshold values of the allocated screens are compared. When the input gradation value is the corresponding threshold value or higher, “1” is outputted. When the input gradation value is lower than the threshold value, “0” is outputted. For example, when the input gradation value at the position of the screen element 5 is 222, the threshold corresponding to the screen element 5 shown in FIG. 5B is 220. Thus, the input gradation value 222 is higher than the threshold value, and “1” is thus outputted.

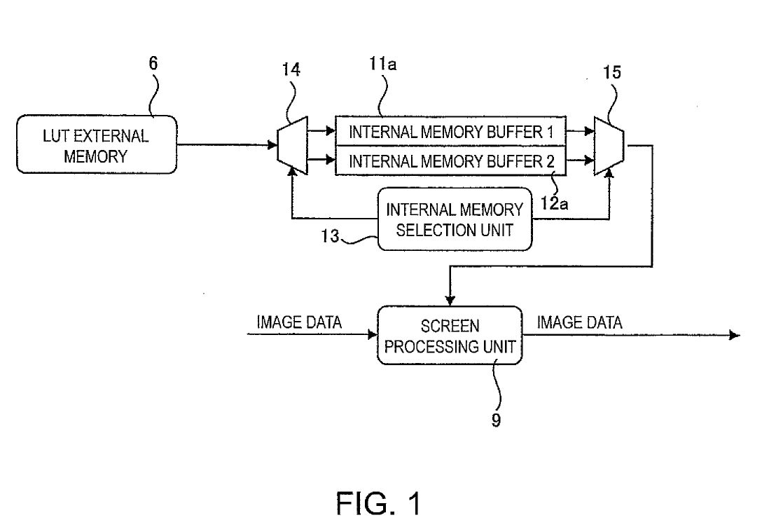

FIG. 1 is a block diagram showing the structure according to this embodiment. Similar reference numbers are given to parts similar to those in FIG. 4, and detailed explanation is not repeated. As illustrated in FIG. 1, an internal memory selection unit 13, internal memory buffers 11a and 12a, and switching gates 14 and 15 are provided, The switching gate 14 is opened in response to a signal sent from the internal memory selection unit 13, and line data (hereinafter referred to as LUT value) corresponding to 1 line from the LUT external memory G is written to either the internal memory buffer 11a or 12a.

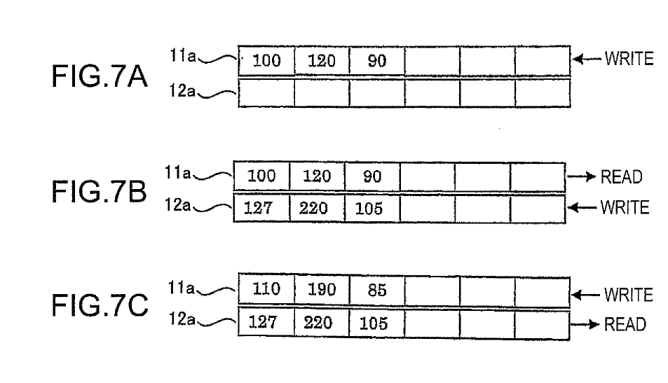

The switching gate 15 is opened in synchronization with this writing process to read the LUT value for one line written to either the internal memory buffer 11a or 12a. The LUT value writing and reading processes for one line to and from the internal memory buffers 11a and 12a will be described in detail later with reference to FIGS. 7A through 7C. Since the LUT values are processed for one line, the screen processing can be efficiently performed without any loss.

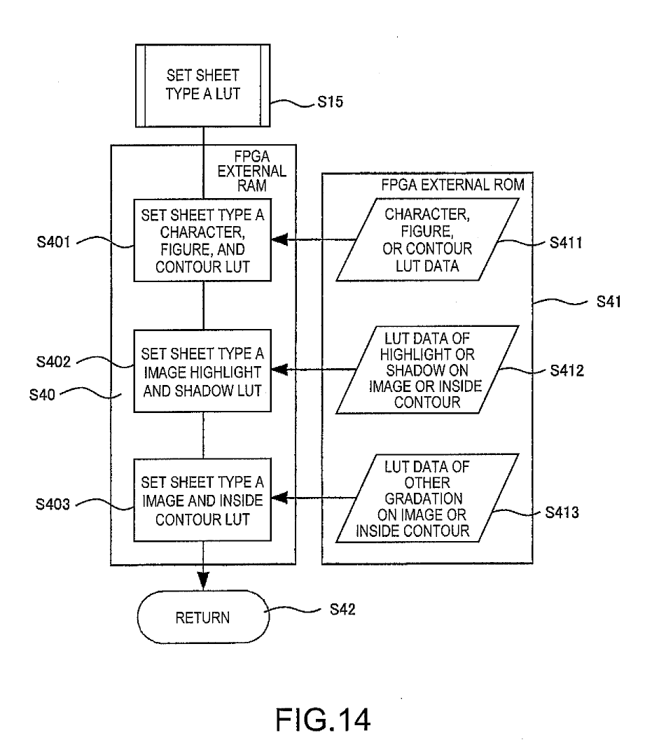

According to this embodiment of the invention, the LUT external memory 6 is defined as a first memory unit, and the internal memories 11 and 12 shown in FIG. 4 are defined as a third memory unit. The internal memory buffers 11a and 12a of FIG. 1 are defined as a first area and a second area, respectively, provided on the third memory unit. A second memory unit will be described later in conjunction with FIG. 14.

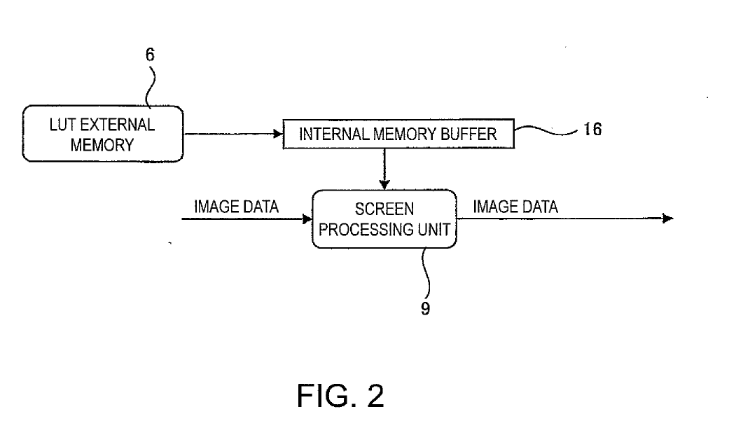

FIG. 2 is a block diagram showing another embodiment of the invention. According to the example in FIG. 2, a single internal memory buffer 16 is provided. Thus, the internal memory selection unit 13 shown in FIG. 1 is not required. In the structure shown in FIG. 2, LUT value for one line is read from the LUT external memory 6 and written to the internal memory buffer 16 at certain timing. At the subsequent timing, the LUT value for one line written to the internal memory buffer 16 is readout. Thus, the LUT value for one line is sequentially read out from the LUT external memory 6 in this manner. That is, writing to the internal memory buffer 16 and reading from the internal memory buffer 16 are alternately performed.

FIGS. 7A through 7C explain an example of the screen processing according to the embodiment of the invention. As shown in FIG. 7A, a table value for the 1st line in the LUT is written to the internal memory buffer 11a at the generation of a page requirement signal, that is, video data request signal (Vreq). According to this example, the table value for 1st line corresponds to thresholds “100, 120, and 90” associated with numbers 1 through 3 in FIG. 5B. When the table value for the 1st line of the LUT is written to the internal memory buffer 11a, the Vreq signal becomes the reference signal. During this process, the LUT value is not written to the internal memory buffer 12a.

FIG. 7B shows the process performed at the first (odd number) generation of the line data request signal (Hreq). In this process, the table value for 1st line of the LUT written to the internal memory buffer 11a is read out. Then, screen processing is performed for the 1st line of the input image, and the obtained data is transmitted. Simultaneously, the table value for the 2nd line of the LUT is written to the internal memory buffer 12a. In this example, the table value for the 2nd line corresponds to thresholds “127, 220, and 105” associated with numbers 4 through 6 in FIG. 5B. Here, Hreq signal becomes the reference signal.

FIG. 7C shows the process performed at the second (even number) generation of Hreq. In this process, the table value for 2nd line of the LUT written to the internal memory buffer 12a is read out. Then, screen processing is performed for the 2nd line of the input image, and the obtained data is transmitted. Simultaneously, the table value for the 3rd line of the LUT is written to the internal memory buffer 11a. In this example, the table value for the 3rd line corresponds to thresholds “110, 190, and 85” associated with numbers 7 through 9 in FIG. 5B.

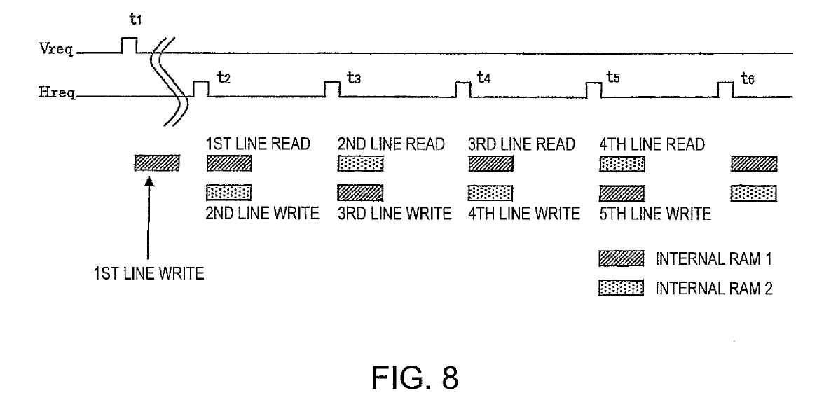

FIG. 8 is a timing chart for performing the process shown in FIGS. 7A through 7C. As can be seen from FIG. 8, the table value for the 1st line of the LUT is written to the internal memory buffer 11a (RAM 1) at the generation of Vreq (t1). Then, the table value for the 1st line in the input image is read out at the 1st (odd number) generation of Hreq (t2), and the screen processing is performed. Simultaneously, the table value for the 2nd line of the LUT is written to the internal memory buffer 12a (RAM 2).

The table value for the 2nd line of the input image is read out from the internal memory buffer 12a at the 2nd (even number) generation of Hreq (t3), and the screen processing is performed. Simultaneously, the table value for the 3rd line of the LUT is written to the internal memory buffer 11a (RAM 1). Thereafter, the table values of the LUT are alternately written to and read from the internal memory buffer 11a and the internal memory buffer 12a for each line at the timing of t4 t5, and t6 in the same manner.

This embodiment of the invention has the following characteristics. (1) The LUT is stored in the external memory (such as DDR2 SDRAM) which is relatively inexpensive. (2) The built-in memory buffer capable of storing the LUT values for 2 lines is provided in the FPGA. (3) The table value for the 1st line of the LUT in the external memory is written to the first internal memory buffer in synchronization with the page requirement signal (Vreq) issued from the printer engine. (4) The LUT value written to the first internal memory buffer is read out in synchronization with the line data request signal (Hreq) issued from the printer engine, and the screen processing for one line is performed. (5) During the screen processing for one line, the table value for the next line of the LUT stored in the external memory of the FPGA is written to the second internal memory buffer in synchronization with the Hreq. (6) Thereafter, reading and writing from and to the first and second internal memory buffers are switched in synchronization with Hreq.

According to this embodiment, therefore, the screen processing can be performed regardless of the size of the LUT table by using the external memory provided outside the FPGA. Even when the table size of LUT is large, the structure of the internal memory of the FPGA having a buffer for two lines is still simple. Thus, the cost of the FPGA can be reduced.

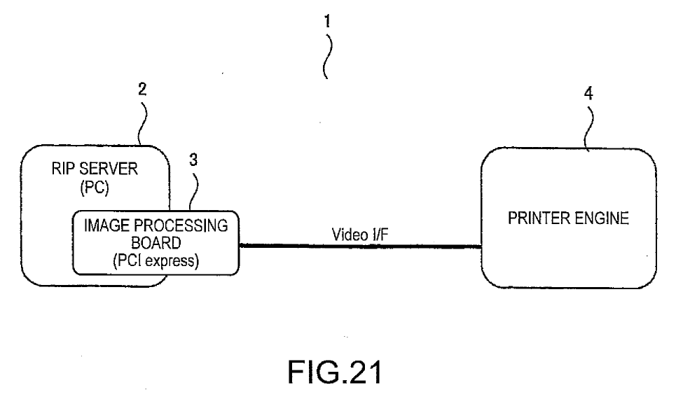

FIG. 21 is a block diagram showing a further embodiment of the invention. As illustrated in FIG. 21, the image forming apparatus 1 includes the image forming unit 2, the image processing board 3, and the printer engine 4. The image forming unit 2 is constituted by an RIP (raster image processor) server of a personal computer (PC). The RIP server functions as an external controller.

The image processing board 3 is an H/W board attached to PCI Express slot or the like of PC, and performs image processing of color conversion process and screen process in this order by using the FPGA (field programmable gate array) 3a provided on the board. The image processing board 3 is connected with the printer engine 4 via the video interface (video I/F).

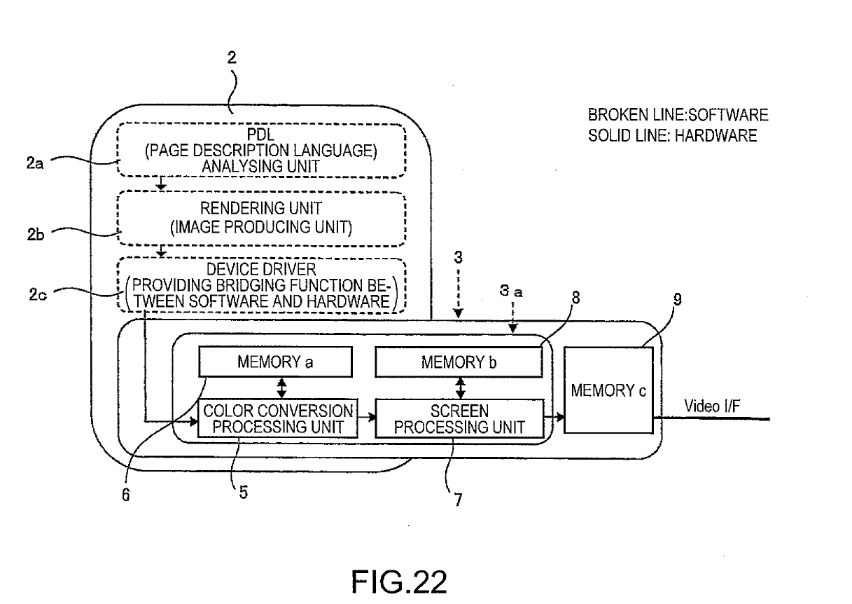

FIG. 22 is a block diagram showing the details of the image forming unit 2 and the image processing board 3. The image forming unit 2 performs predetermined software processing by using a PDL (page description language) analyzing unit 2a, a rendering unit (image producing unit) 2b, and a device driver (providing bridging function between software and hardware) 2c. The image processing board 3 has a memory 6(a) for storing color conversion table to be used by a color conversion processing unit 5, a memory 8(b) for storing screen table to be used by a screen processing unit 7, and a memory 9(c) for storing process results from the screen processing unit 7. The memory 6(a) and the memory 8(b) use internal RAM of the FPGA 3a. The memory 9(c) uses external RAM such that the process results for one page can be stored. The memory 9(c) is so prepared as to output image data according requirement from the printer engine 4.

The image processing is performed with reference to the values of the table (LUT) stored in the internal memory of the FPGA during processing of respective images, Possible printing environment includes environment where printing is performed from a client PC connected with the server PC via network or the like, and environment where printing is performed from the server PC. When printing is conducted by application installed in the client PC or server PC, page description language (PDL; such as post script) is transmitted. Then, the server PC analyzes the PDL and carries out printing.

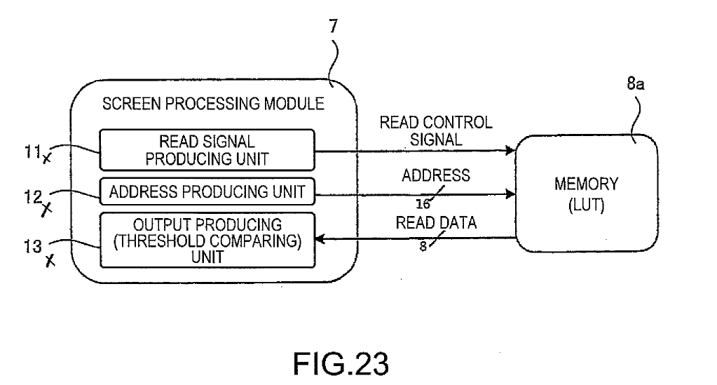

FIG. 23 is a block diagram showing this embodiment of the invention. FIG. 23 illustrates module structure of 1-bit system or 8-bit system, for example. As can be seen from FIG. 23, the screen processing module 7 has a read signal producing unit 11x, an address producing unit 12x, and an output producing (threshold comparing) unit 13x. The read signal producing unit 11 produces control signals for reading memory. The address producing unit 12 produces address signals of memory. The output producing unit 13 performs processing corresponding mode (⅛-bit) to produce output values.

The read control signal and the address signal outputted from the respective signal producing units 11 and 12 of the screen processing module 7 are inputted to the memory (LUT) 8a. Read data from the memory 8a is inputted to the output producing (threshold comparing) unit 13. The numerals “16” of the address line and “8” of the read data line represent data width (bit width).

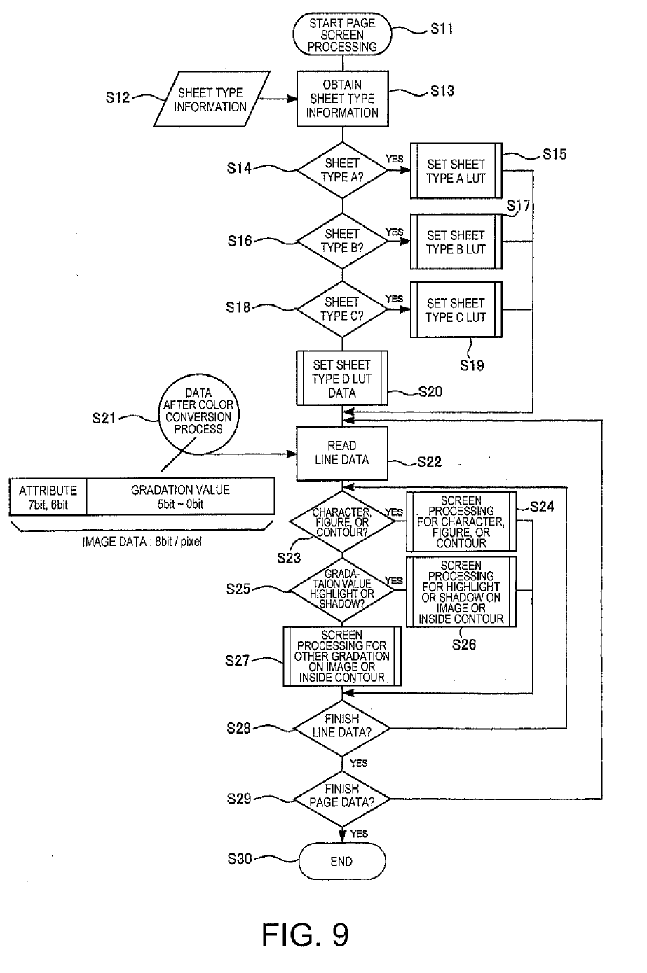

FIG. 9 is a flowchart showing the procedures of the screen processing. Page screen process starts in S11. Then, sheet type information (transfer medium type) subject to printing is referred to in S12, and the sheet type information is obtained in S13. It is judged whether the sheet type is sheet type A or not in S14. When the judgment result is Y, lookup table (LUT) for sheet type A is set in S15. When the judgment result is N in S14, the process goes to S16 and judges whether the sheet type is sheet type B or not. When the judgment result is Y, lookup table (LUT) for sheet type B is set in S17. When the judgment result is N in S16, the process goes to S18 and judges whether the sheet type is sheet type C or not. When the judgment result is Y, lookup table (LUT) for sheet type C is set in S19. When the judgment result is N in S18, the process goes to S20 and sets lookup table (LUT) for sheet type D.

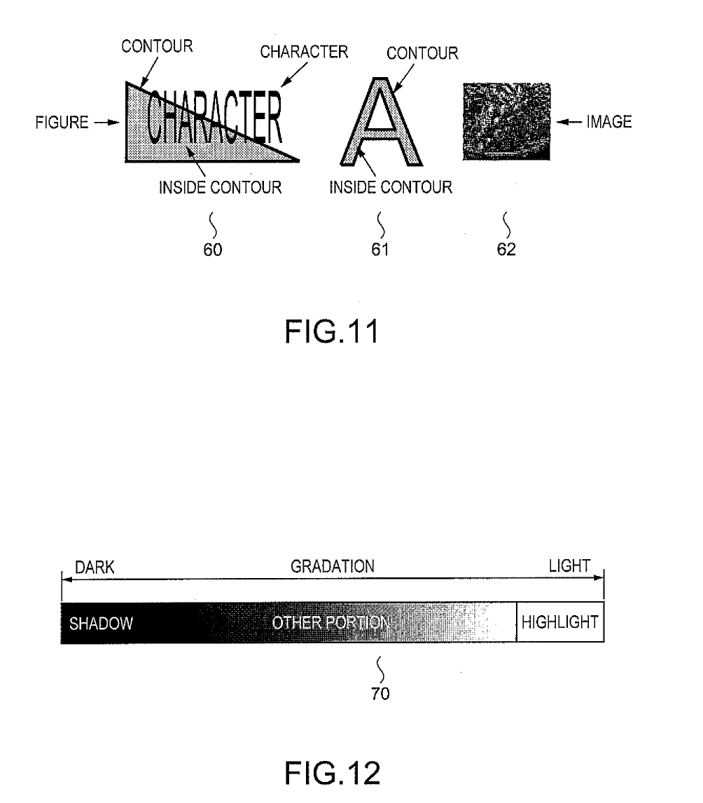

Then, the data after color conversion process is stored in the memory in S21. This image data is constituted by attributes of 6 bits or 7 bits, and gradation values of 0 to 5 bits, for example. Subsequently, line data is read in S22, and it is judged whether the line data is associated with character, figure, or contour in S23. Examples of character, figure, and contour of the line data will be described later with reference to FIG. 11. When the judgment result is Y in S23, the screen processing for character, figure, or contour is performed in S24. When the judgment result is N in S23, the process goes to S25, and judges whether the line data is associated with gradation value, highlight portion, or shadow portion. Examples of gradation value, highlight portion, and shadow portion of the line data will be described later with reference to FIG. 12. When the judgment result is Y in S25, highlight or shadow screen processing for is performed for the image (character or figure) or inside the contour of the line data in S26.

When the judgment result is N in S25, the process goes to S27 and performs screen processing of other gradation is performed for the image (character or figure) or inside the contour of the line data. Then, it is judged whether the processing for the line data is finished or not in S28. When the judgment result is N in S28, the process returns to S23 to repeat the loop processes from S23 to S28. When the judgment result is Y in S28, it is judged whether the page data process is finished or not in S29. When the judgment result is N, the process returns to S22 to repeat loop processes from S22 to S29. When the judgment result is Y, the process ends in S30. Since recording sheet is used as recording medium in this example, the sheet types A through D are judged. However, other recording media may be used.

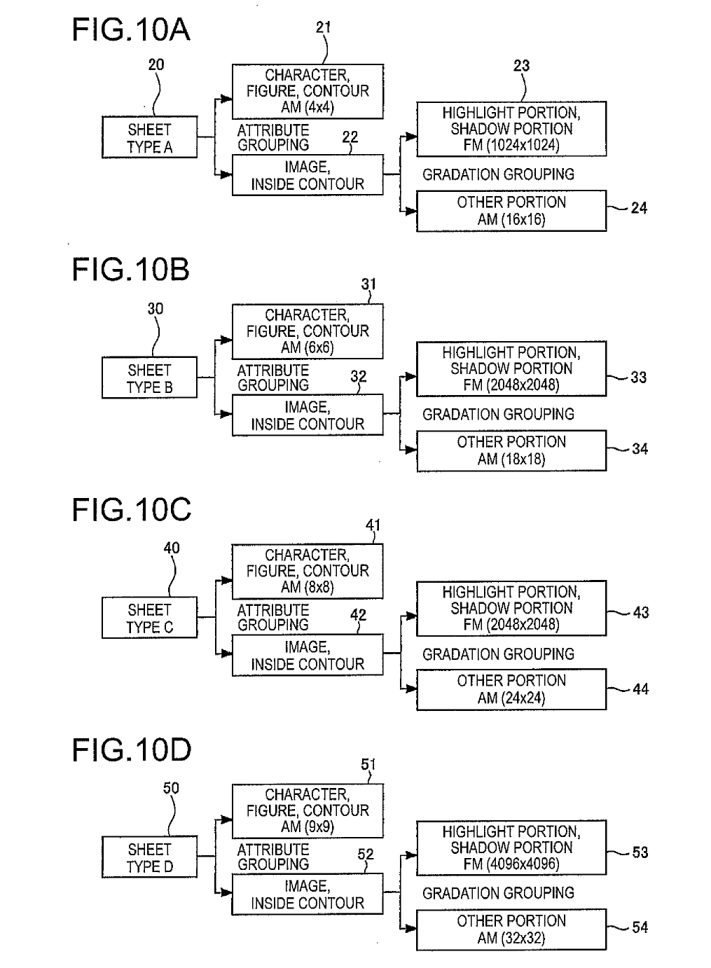

FIGS. 10A through 10D show examples of the contents of the screen table (LUT) constituted prior to the screen processing shown in FIG. 9. In these examples, the contents of the screen table are separated into groups according to the sheet types, attributes, and gradation values. FIG. 10A shows the contents of the screen table for sheet type A, 10B shows those for sheet type B, 10C shows those for sheet type C, and 10D shows those for sheet type D. Character, figure, and contour (21) in the attribute group of sheet type A (20) shown in FIG. 10A have AM (4×4) dot size. Highlight portion and shadow portion (23) in the gradation value group of image and inside contour (22) have FM (1024×1024) dot size. Other portion (24) has AM (16×16) dot size. In this case, the AM screen has small screen capacity, while the FM screen has large screen capacity.

Character, figure, and contour (31) in the attribute group of sheet type B (30) shown in FIG. 10B have AM (6×6) dot size. Highlight portion and shadow portion (33) in the gradation value group of image and inside contour (32) have FM (2048×2048) dot size. Other portion (34) has AM (18×18) dot size.

Character, figure, and contour (41) in the attribute group of sheet type C (40) shown in FIG. 10C have AM (3×8) dot size. Highlight portion and shadow portion (43) in the gradation value group of image and inside contour (42) have FM (2048×2048) dot size. Other portion (44) has AM (24×24) dot size.

Character, figure, and contour (51) in the attribute group of sheet type D (50) shown in FIG. 10D have AM (9×9) dot size. Highlight portion and shadow portion (53) in the gradation value group of image and inside contour (52) have FM (4096×4096) dot size. Other portion (54) has AM (32×32) dot size.

FIG. 11 illustrates the definitions for distinction of the character, figure, contour, image, and inside of contour shown in FIG. 9 and FIGS. 10A through 10D. An example 60 shows a combination of character and figure, defining the boundary for separating the figure and the white portion as contour, and the inside of the boundary of the figure as inside of contour. An example 61 defines the outer peripheral boundary of decorated alphabet “A” as contour, and the portion between the outer peripheral boundary and inner peripheral boundary of the alphabet “A” as inside of contour. An example 62 represents an example of image.

FIG. 12 shows the relationship between the gradation value and the highlight and shadow portions. According to the example shown in FIG. 12, the portion having density of 1 to 10% is defined as highlight portion, and the portion having density of 90 to 99% is defined as shadow portion, and the portion between the highlight portion and the shadow portion is defined as other potion.

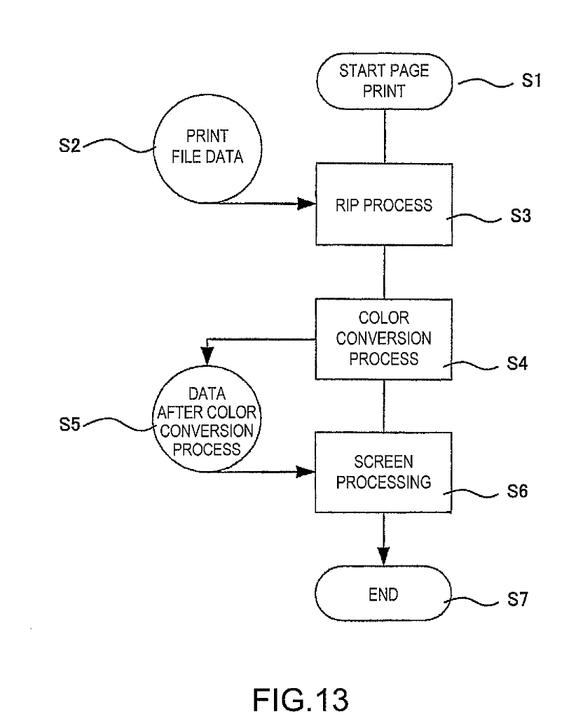

FIG. 13 is a flowchart showing the procedures of the printing process in this embodiment. As shown in FIG. 13, page printing starts in S1. Then, print file is referred to in S2, and RIP process is performed in S3. Subsequently, color conversion process is performed in S4, and the data after color conversion processed is stored in the memory in S5. Finally, the color conversion processed data is read from the memory to conduct screen processing in S6, and the process ends in S7.

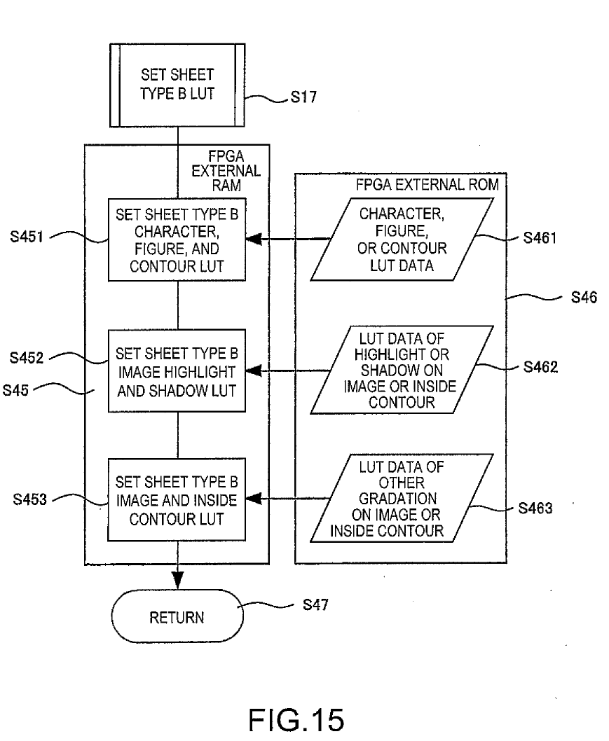

FIGS. 14 and 15 are flowcharts each of which shows sub routine for setting screen according to sheet type. In FIG. 14, S15 corresponds to lookup table (LUT) set for sheet type A shown in FIG. 9. In this case, LUT data stored in FPGA external ROM is read out to set three types of LUT areas in FPGA external RAM.

Step S41 is a process for storing LUT data in the FPGA external ROM. In this step, LUT data of character, figure, or contour is stored in S411. Then, highlight or shadow LUT data of the image or inside the contour is stored in S412. Finally, LUT data of the image or inside the contour having other gradations is stored in S413.

Step S40 is a process for setting the screen table (LUT) in the FPGA external RAM. In this step, LUT of character, figure, or contour for sheet type A is set in S401. Then, highlight or shadow LUT of the image of sheet type A is set in S402. Finally, LUT inside the contour of the image for the sheet type A is set in S403. According to this embodiment, therefore, the first memory unit constituted by the FPGA external RAM and the second memory unit constituted by the FPGA external ROM are provided. The screen processing unit selects screen data separated into groups according to information about recording medium on which image is printed, attributes of print image data, and gradation values of print image data from the second memory unit, and stores the selected screen data in the screen table as the first memory unit according to the type of the recording medium having been set.

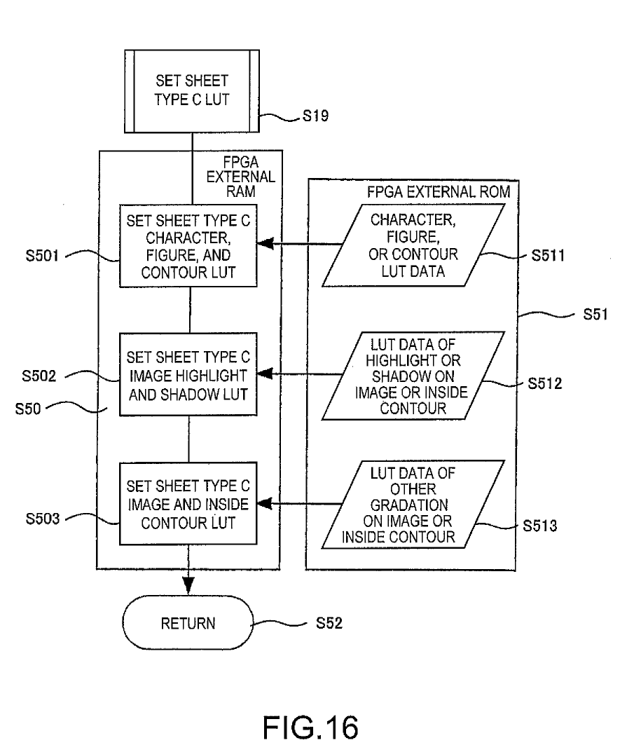

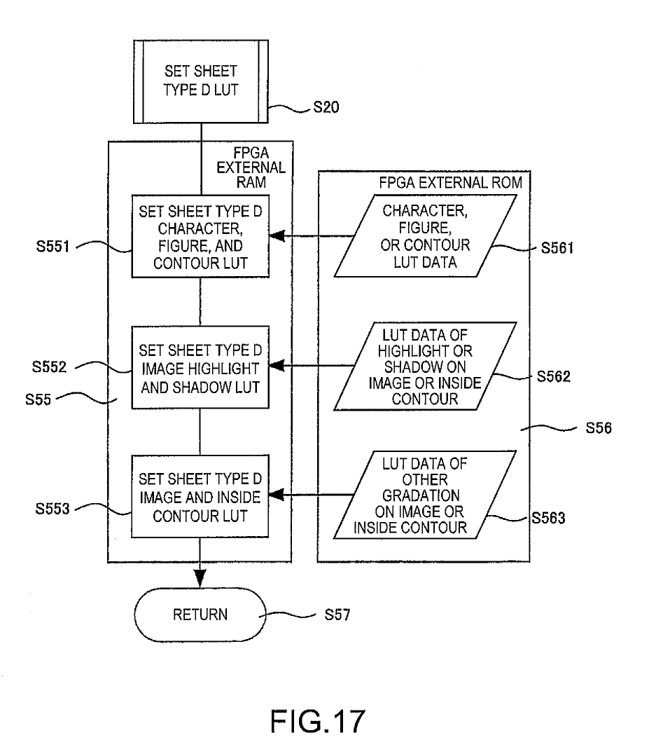

FIG. 15 corresponds to LUT set for sheet type B shown in FIG. 9. FIG. 16 corresponds to LUT set for sheet type C shown in FIG. 9. FIG. 17 corresponds to LUT set for sheet type D shown in FIG. 9. The processes performed for LUT setting shown in FIGS. 15 through 17 are similar to those shown in FIG. 14 only with changes for sheet types B through D, and thus the same detailed explanation is not repeated.

As described with reference to FIGS. 14 through 17, the sheet type can be selected for each page such that screen appropriate for the selected sheet can be used in the embodiment of the invention. While one type is selected from four types of sheet in this embodiment, one type is selected from a larger number types of sheet in practical use. Default screen table data is stored in a memory (such as flash memory) outside the FPGA (or ASIC), and transferred to the external RAM before start of page printing. Though not shown in the figure, screen table data exclusively used by the user is written to the external RAM. In this embodiment, therefore, the screen table to be referred to is switched and read out according to image data containing data attribution information and gradation values at the time of printing on the recording medium to perform screen processing.

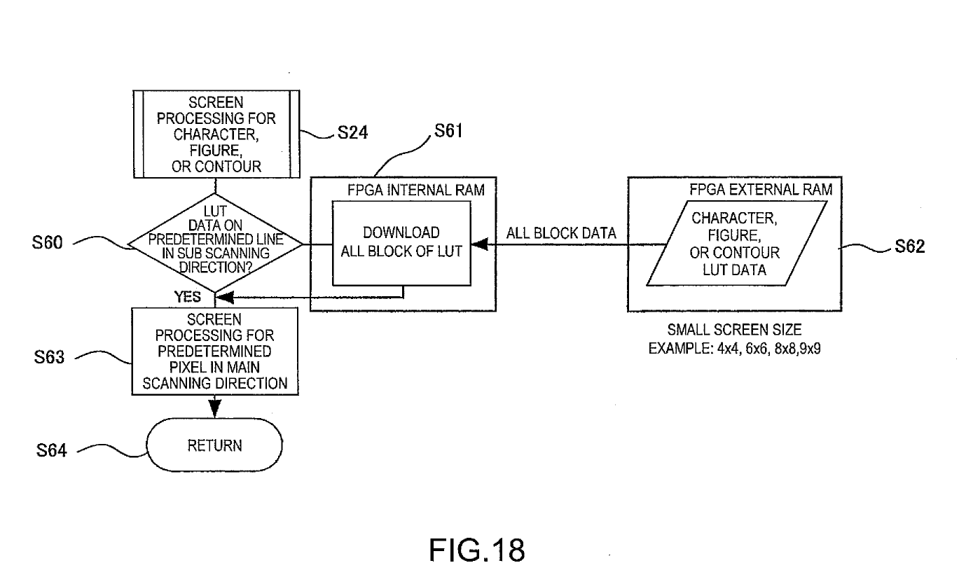

FIGS. 18 through 20 are flowcharts showing sub routines of the respective screen processing performed according to attributes. The process in S24 of FIG. 18 corresponds to the screen process executed for character, figure, and contour explained in S24 in FIG. 9. Then, it is judged whether data is LUT data of a predetermined line in the sub scanning direction (rotational direction of photosensitive body) in S60. When the judgment result is Y, the screen process is performed for predetermined pixels in the main scanning direction (axial direction of photosensitive body) in S63. Then, the process returns in S64.

When the judgment result is N in S60, all blocks of the LUT are downloaded to the FPGA internal RAM in S61. The LUT data for character, figure, and contour is stored in the FPGA external RAM in advancer and all block data is read out in S62. In this example, the screen size is small for highly accurate representation of character, figure, and contour. For example, the screen size is 4×4 dots, 6×6 dots, 8×8 dots, and 9×9 dots. When the screen size is small, all blocks of the screen table data are downloaded from the FPGA external RAM to the FPGA internal RAM at a time to increase the entire efficiency.

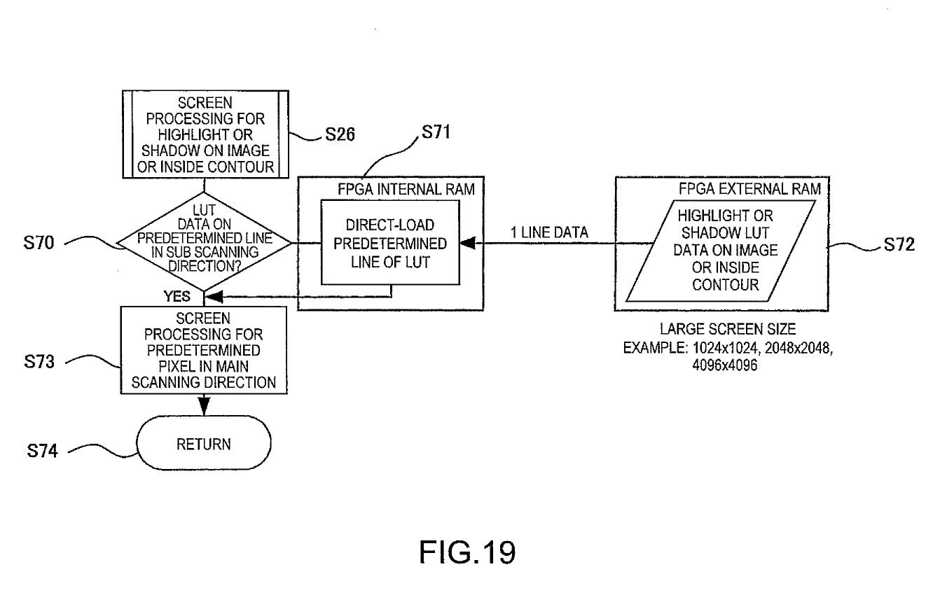

The process in S26 shown in FIG. 19 corresponds to the highlight and shadow screen process performed for the image (character and figure) of the line data or inside the contour as explained in S26 in FIG. 9. Then, it is judged whether data is LUT data of a predetermined line in the sub scanning direction (rotational direction of photosensitive body) in S70. When the judgment result is Y, the screen process is performed for predetermined pixels in the main scanning direction (axial direction of photosensitive body) in S73. Then, the process returns in S74.

When the judgment result is N in S70, the LUT is direct-loaded for the predetermined line to the FPGA internal RAM in S71. The LUT data for highlight and shadow is stored in the FPGA external RAM in advance, and one line data is read out in S72. In this step, the screen size of the highlight portion or shadow portion of the image or inside the contour judged by the process in FIG. 9 based on the gradation value of the printing data is increased to produce FM screen. For example, the screen size is 1024×1024 dots, 2048×2048 dots, and 4096×4096 dots. For producing the large screen, only one line in the main scanning direction of the screen is direct-loaded as the line is required.

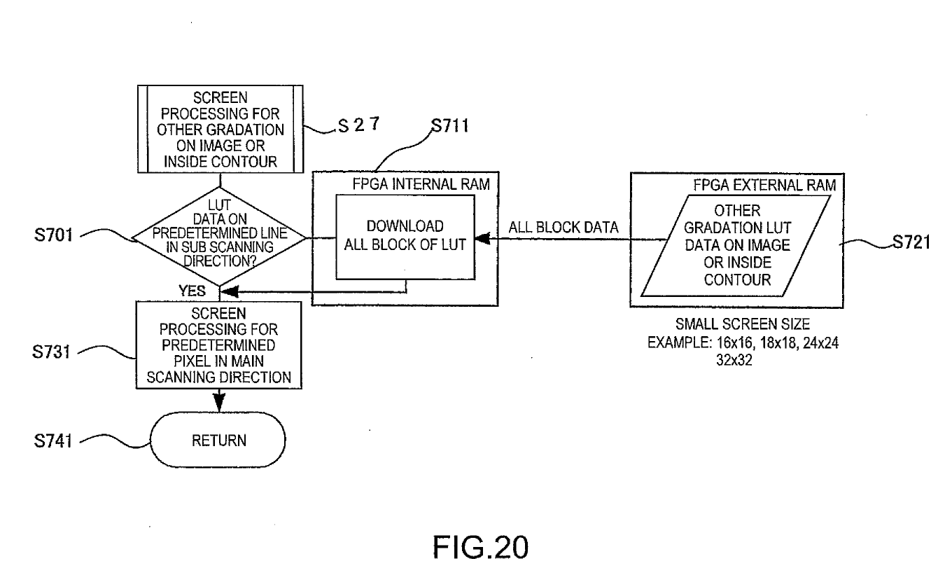

The process in S27 in FIG. 20 corresponds to other screen process performed for the image of the line data (character or figure) or inside the contour explained in S27 in FIG. 9, Then, it is judged whether data is LUT data of a predetermined line in the sub scanning direction (rotational direction of photosensitive body) in S701. When the judgment result is Y, the screen process is performed for predetermined pixels in the main scanning direction (axial direction of photosensitive body) in S731. Then, the process returns in S741.

When the judgment result is N in S701, all blocks of the LUT are downloaded to the FPGA internal RAM in S711. The LUT data is stored in the FPGA external RAM in advance, and all block data is read out in S721. In this example, the relatively small screen is used for the image and other gradation portion (11% to 89%), and thus all block data of the screen table data are downloaded from the FPGA external RAM to the FPGA internal RAM at a time. For example, the screen size is 16×16 dots, 18×18 dots, 24×24 dots, and 32×32 dots. The screen size in the respective examples is not limited to those shown above, but may be arbitrarily determined at the time of design for increasing image quality.

Accordingly, the screen table data of the screen table having relatively small capacity size such as AM screen is downloaded to the internal RAM of the screen processing device of the printer at a time. On the other hand, the screen table data of the screen table having large capacity size such as FM screen is downloaded from the external RAM of the screen processing device to the internal RAM of the printer for each line such that the screen processing can be performed. That is, the data of the screen table having small capacity size is downloaded to the internal memory of the screen processing device of the printer at a time, and the data of the screen table having the large capacity size is downloaded from the external memory of the screen processing device of the printer to the internal memory for each line such that the screen processing can be performed.

In this embodiment, the screen table is separated into groups according to sheet types, attributes, and gradation values such that screen appropriate for the purpose can be selected. Attributes of character, figure, and image are added to the upper bits of the image data at the time of RIP process (other bytes paired with the data are used in some cases). The information about the contour and inside contour is judged such that contour is equivalent to character and figure and that inside contour is equivalent to image based on edge detection from the printing data. By this method, the contour and inside contour information becomes common attribute data.

According to this embodiment, the RAM resource for the screen table occupying the inside of the FPGA can be reduced to the minimum. Also, the screen table is separated into groups according to sheet types, attributes, and gradation values such that screen appropriate for the purpose can be selected. Thus, reproducibility of images can be enhanced. According to this embodiment, therefore, the screen processing is reasonably performed, and increase in the internal memory capacity of the printer is prevented. As a result, cost reduction can be achieved.

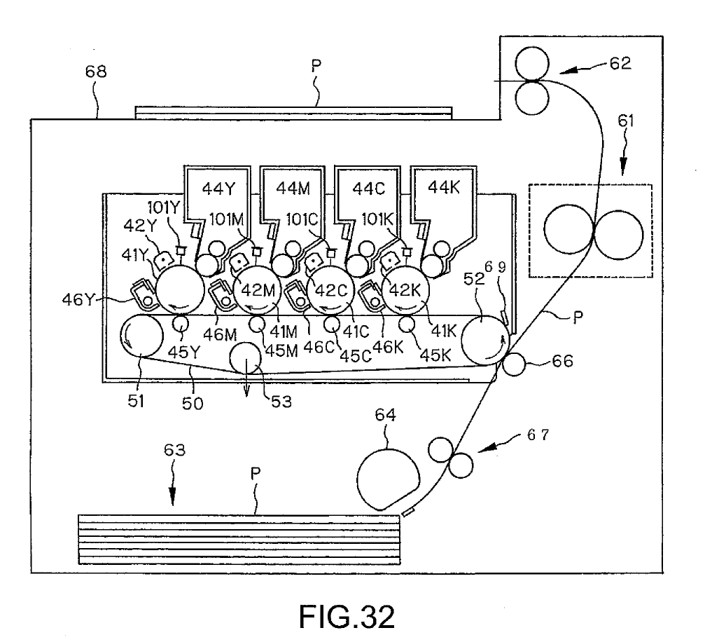

The method according to this embodiment is applied to a line head included in a tandem type color printer (image forming apparatus), where four color images are simultaneously formed by exposing four photosensitive bodies using four line heads and transferred to one endless intermediate transfer belt (intermediate transfer medium). FIG. 32 is a vertical cross-sectional side view illustrating an example of the tandem type image forming apparatus which includes organic EL element as light emission element. This image forming apparatus has four line heads 101K, 101C, 101M, and 101Y having similar structure and disposed at exposure positions of four photosensitive bodies (image carriers) 41K, 41C, 41M, and 41Y having similar structure and corresponding to the line heads 101K, 101C, 101M, and 101Y.

As illustrated in FIG. 32, the image forming apparatus includes a drive roller 51, a driven roller 52, a tension roller 53, and an intermediate transfer belt (intermediate transfer medium) 50 circulated in the direction indicated by arrows in the figure (anticlockwise direction) by the tension roller 53. The photosensitive bodies 41K, 41C, 41M, and 41Y are disposed at predetermined intervals with respect to the intermediate transfer belt 50. The symbols K, C, M, and Y added after the numbers represent black, cyan, magenta, and yellow. The photosensitive bodies 41K through 41Y are rotated in the direction indicated by arrows in the figure (clockwise direction) in synchronization with the drive of the intermediate transfer belt 50. Electrifying units 42 (K, C, M, and Y) and the line heads 101 (K, C, M, and Y) are provided around the respective photosensitive bodies 41 (K, C, M and Y).

These line heads (exposure heads) are constituted by micro-lenses having negative optical power as the image forming system, for example. The image forming apparatus also includes light emission elements disposed in the rotational axis direction and rotational direction of the image carrying bodies.

The image forming apparatus further includes developing devices 44 (K, C, M, and Y) which add toner as developer to electrostatic latent images formed by the line heads 101 (K, C, M, and Y) to produce visible images, primary transfer rollers 45 (K, C, M, and Y), and cleaning devices 46 (K, C, M, and Y). The light emission energy peak wavelengths of the respective line heads 101 (K, C, M, and Y) substantially coincide with the sensitivity peak wavelengths of the photosensitive bodies 41 (K, C, M, and Y).

The respective toner images in black, cyan, magenta, and yellow formed by the four monochrome toner image forming stations are sequentially transferred onto the intermediate transfer belt 50 as primary transfer by primary transfer bias applied to the primary transfer rollers 45 (K, C, M, and Y) The full-color toner image formed by sequentially stacking the respective color toner images on the intermediate transfer belt 50 is transferred to a recording medium P such as sheet as secondary transfer by using a secondary transfer roller 66. Then, the transferred full-color toner image is fixed to the recording medium P while passing through a pair of fixing rollers 61 as fixing unit, and discharged onto a sheet discharge tray 68 provided in the upper area of the apparatus by using a pair of sheet discharge rollers 62.

The image forming apparatus further includes a feed sheet cassette 63 for supporting a number of accumulated sheets of the recording medium P, a pickup roller 64 which feeds the recording medium P from the sheet feed cassette 63 sheet by sheet, a pair of gate rollers 67 which regulate supply timing of the secondary transfer roller 66 for supplying the recording medium P to the secondary transfer unit, the secondary transfer roller 66 as the secondary transfer member for forming the secondary transfer unit between the intermediate transfer belt 50 and the secondary transfer roller 66, and a cleaning blade 69 which removes toner remaining on the surface of the intermediate transfer belt 50 after secondary transfer.

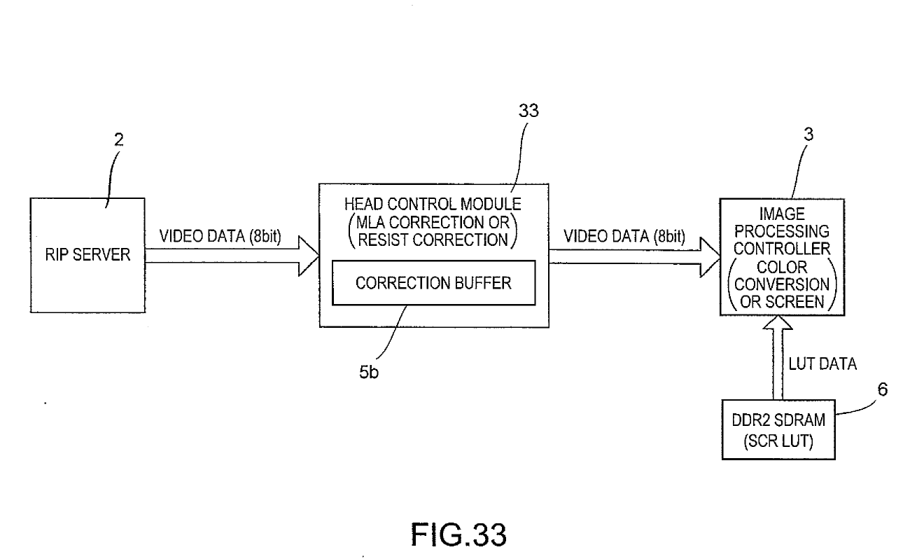

According to this embodiment, the image forming system of the line heads 101 (Y, M, C, and K) explained with reference to FIG. 32 includes micro-lens array (MLA) having negative optical power. The light outputted from the light emission element is inverted in the axial direction and rotational direction of the photosensitive body while passing through the MLA. Thus, the arrangement of image data needs to be switched for forming a normal latent image on the photosensitive body. FIG. 33 is a block diagram schematically showing an example of the screen processing performed after image data inverting process by the MLA.

In FIG. 33, similar reference numbers are given to parts similar to those of the structure shown in FIG. 2. The RIP server 2 corresponds to external PC in FIG. 2, and the image processing controller 3 corresponds to image processing board (printer controller) shown in FIG. 2. The image processing controller 3 reads LUT data from LUT external memory (DDR2 SDRAM) to perform color conversion process and screen process.

A line head control module 33 performs MLA correction (switching of arrangement of image data) discussed above and resist correction. The line head control module 33 has a correction buffer 5b. According to the structure shown in FIG. 33, the line head control module 33 carries out MLA correction and resist correction discussed above for 8-bit video data outputted from the RIP server 2. Then, the line head control module 33 outputs the 8-bit video data after MLA correction and resist correction to the image processing controller 3. The image processing controller 3 performs screen processing for the image data after MLA correction.

Thus, the structure shown in FIG. 33 performs screen processing for the video data outputted from the RIP server 2 after MLA correction is finished. Thus, the correction buffer 5a requires 8-bit capacity, and the cost increases. Moreover, the transmission data amount between the line head control module 33 and the image processing controller 3 becomes 8 bits, which also raises the cost. When a plurality of micro-lenses of the image forming system are disposed in each of the axial direction and rotational direction of the photosensitive bodies, both switching of arrangement of image data within each of the micro-lenses and switching of arrangement of image data between each of the micro-lenses are needed. In this case, matching the screen with the image data is difficult after MLA correction.

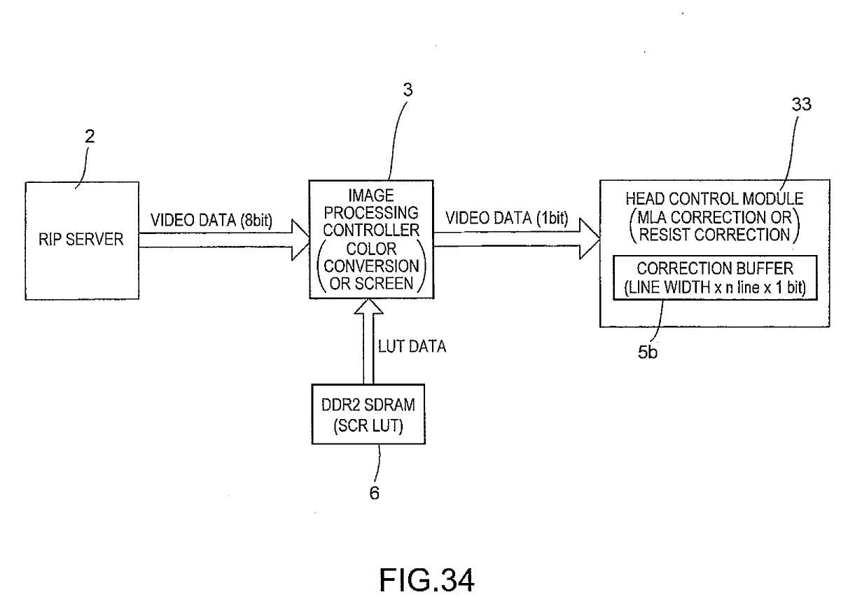

FIG. 34 is a block diagram showing a structure which can solve the problem arising from the structure shown in FIG. 33. According to the structure in FIG. 34, the image processing controller 3 performs screen processing for the video data outputted from the RIP server 2 first, and then the line head control module 33 carries out MLA correction. In this case, the transmission data amount between the image processing controller 3 and the line head control module 33 is decreased to 1 bit. Also, the necessary capacity of the correction buffer 5a is only 1 bit. Moreover, no problem arises from the screen processing even after MLA correction.

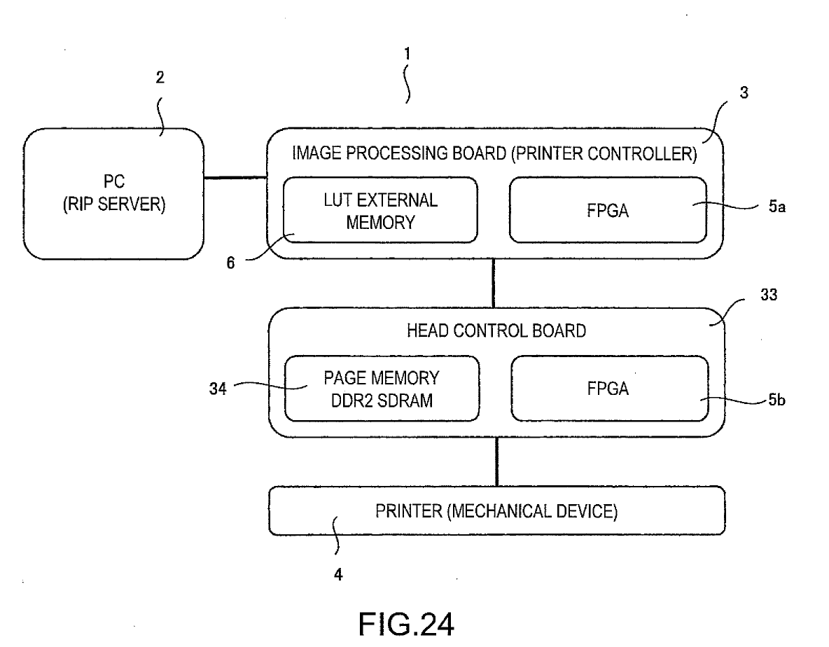

FIGS. 24 through 29, FIGS. 30A through 30C, and FIG. 31 show structures according to this embodiment corresponding to the structure shown in FIG. 34. FIG. 24 is a block diagram of a control unit 1 of the image forming apparatus. Similar reference numbers are given to parts similar to those in FIGS. 3 and 34, and detailed explanation is not repeated. Video data outputted from the PC (RIP server) 2 is stored in a page memory 34 of the line head control board (line head control module) 33.

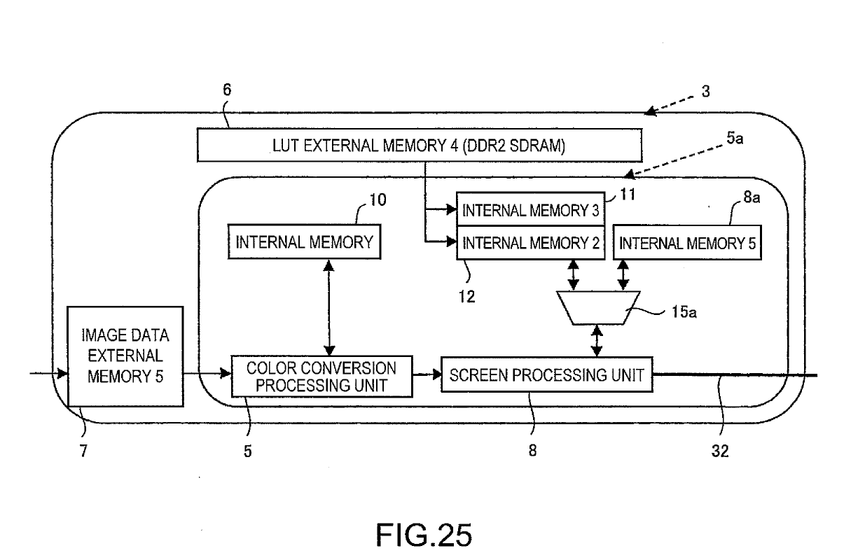

FIG. 25 is a block diagram showing the details of the image processing board (printer controller) 3 shown in FIG. 24. Similar reference numbers are given to parts similar to those in FIG. 4, and detailed explanation is not repeated. The internal memories 11 and 12 shown in FIG. 25 are memory units for screen processing as explained with reference to FIG. 4. The internal memory 8a is a memory unit for storing image data to which screen processing has been applied to use the image data for MLA correction. The switching gate 15a switches between access to the internal memories 11 and 12 and access to the internal memory 8a.

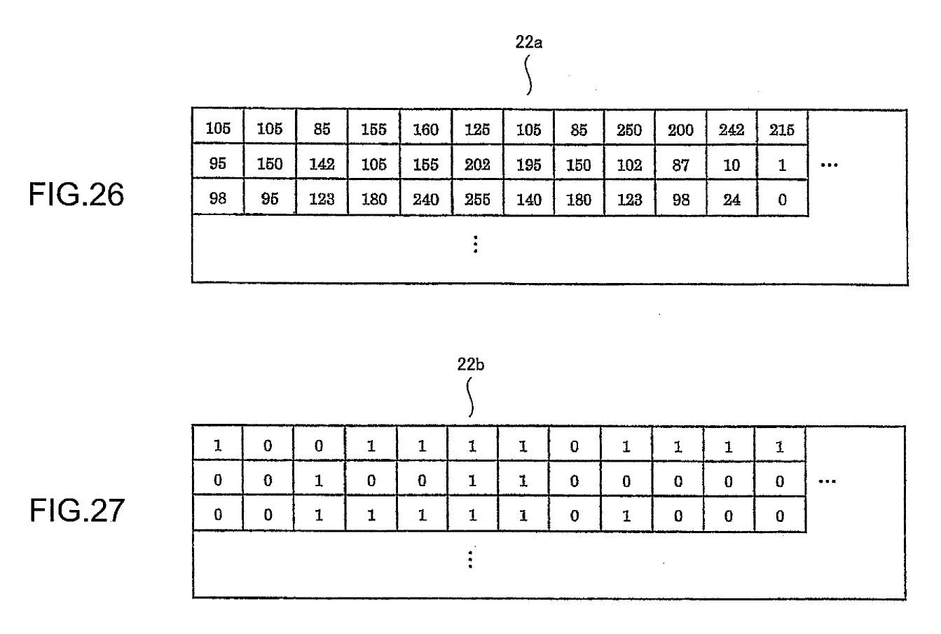

FIG. 26 shows an example which allocates an input image to screens in correspondence with FIG. 6. Numerals 105, 105, 85, and others of FIG. 26 are gradation values allocated to screens 1, 2, 3, and others shown in FIG. 5A. FIG. 27 shows output data which compares gradation values shown in FIG. 26 and thresholds stored in the memory shown in FIG. 5B. For example, the input gradation value 105 is larger than 100 as the threshold of memory 1, and therefore the comparison result is “1”. Also, the input gradation value 105 is smaller than 120 as the threshold of memory 2, and therefore the comparison result is “0”. Other input gradation values are compared with the thresholds in this manner, That is, “1” is outputted when the input gradation value is large, and “0” is outputted when the input gradation value is small.

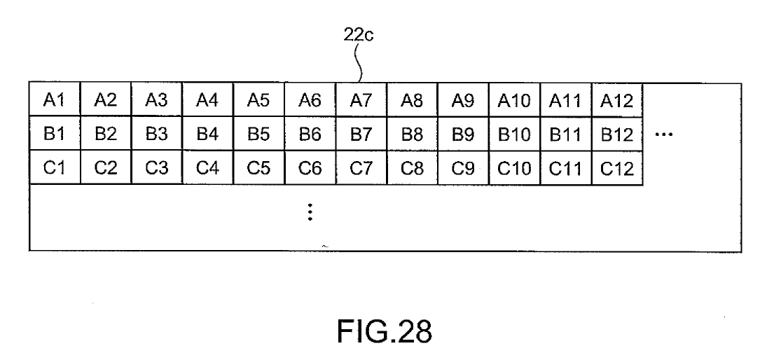

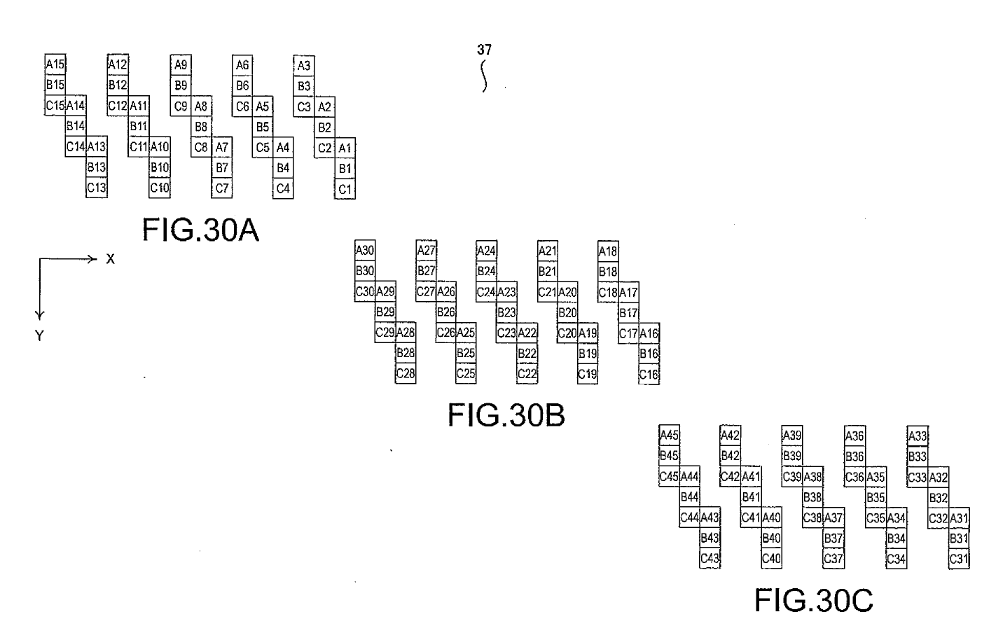

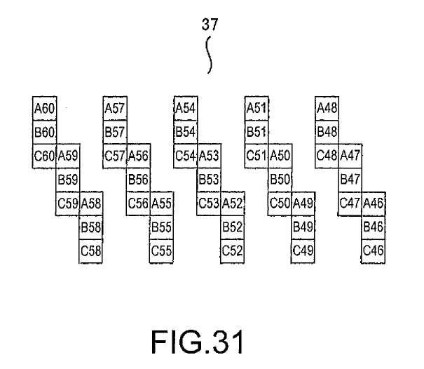

FIG. 28 shows an example of arrangement of MLA correction image data 22c stored in the memory after screen processing. image data A1 through A12 and others are stored on the 1st line of the memory, and image data B1 through B12 and others are stored on the 2nd line of the memory. Furthermore, image data C1 through C12 and others are stored on the 3rd line of the memory. The arrangement of these image data will be described later with reference to FIGS. 30A through 30C and FIG. 31.

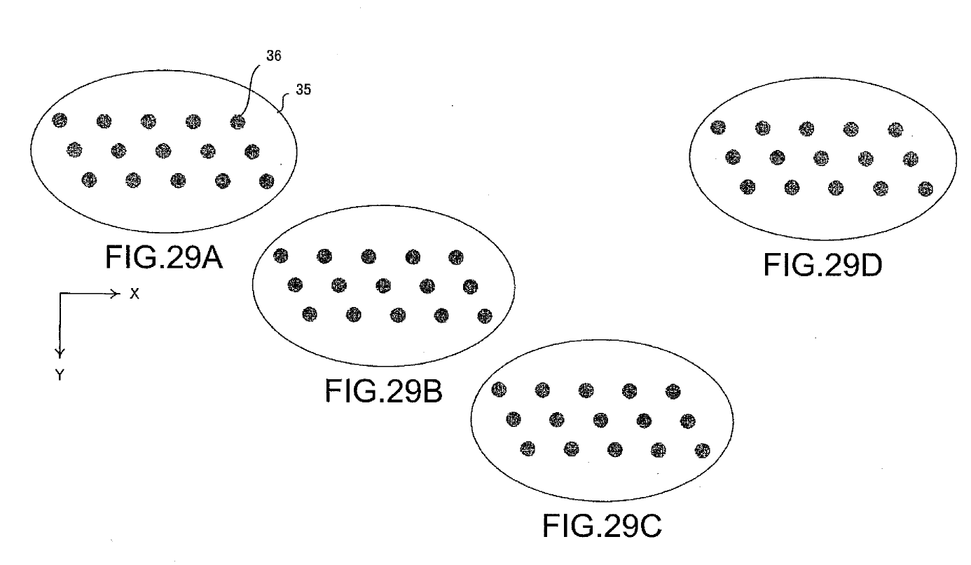

FIG. 29 shows an example of micro-lenses 35 and light emission elements 36 disposed inside the micro-lenses 35. As illustrated in FIG. 29, the plural micro lenses 35(a) through 35(d) are disposed in the axial direction (X direction) and rotational direction (Y direction) of the photosensitive body. The plural light emission elements 36 are disposed inside each of the micro lenses 35 in the axial direction (X direction) and rotational direction (Y direction) of the photosensitive body.

FIGS. 30A through 30C and FIG. 31 schematically show arrangements 37 of image data stored in the memory with respect to the light emission elements 36 shown in FIG. 29. FIGS. 30A through C and FIG. 31 correspond to the micro-lenses 35(a) through 35(d) shown in FIG. 29. The number of the light emission elements disposed within each micro-lens differs from that shown in FIG. 29, and 15 light emission elements are disposed in the axial direction (X direction) of the photosensitive body. As for the overall axial direction (X direction) of the photosensitive body, image data for 60 light emission elements are formed as A1 through A60, for example. The light emission elements are disposed on three lines in the rotational direction (Y direction) of the photosensitive body similarly to the light emission elements shown in FIG. 29. As discussed above, according to the structure using micro-lenses having negative optical power, the output light from the light emission elements is inverted in the axial direction and rotational direction while passing through the micro-lenses. Thus, the arrangement of the image data needs to be switched so as to form normal latent images on the photosensitive bodies.

According to the example shown in FIG. 30A, image data A15, A12, A9, A6, and A3 are stored on the 1st line in the Y direction in the memory. Also, image data B15, B12, B9, B6, and B3 are stored on the 2nd line in the Y direction in the memory, and image data C15, C12, C9, C6, and C3 and image data A14, A11, A8, A5, and A2 are stored on the 3rd line in the Y direction in the memory.

Similarly, the image data A, B, and C are stored on the 4th through 7th line in the rotation direction of the photosensitive body in the memory in the same manner. For example, the image data A1 stored on the 5th line in the rotational direction and at the 15th position in the axial direction of the photosensitive body is inverted in the rotational direction (Y direction) and disposed on the 1st line in the rotational direction of the photosensitive body. Then, the image data A1 is inverted in the axial direction (X direction) of the photosensitive body and disposed at the write position. Thus, according to the arrangements of the image data shown in FIGS. 30A through 30C and FIG. 31, the alphabets A, B, and C correspond to the rotational direction of the photosensitive body, and the numerals 1 through 60 correspond to the axial direction of the photosensitive body.

According to the embodiments described above, the image processing device, the image forming apparatus, ad the image forming method capable of maintaining the cost of the internal memory of the FPGA and efficiently performing screen processing have been discussed on the basis of examples. However, the invention is not limited to those examples, and it is intended that various modifications may be made.

The entire disclosure of Japanese Patent Application Nos: 2007-315444, filed Dec. 6, 2007 and 2008-225539, filed Sep. 3, 2008 are expressly incorporated by reference herein.

What is claimed is:

1. An image processing device comprising:
a first memory unit that receives screen data selected from a plurality of screen data stored in a second memory unit and stores the received screen data; and
a third memory unit that has a first area for receiving first line data as line unit data of screen data stored in the first memory unit and for storing the first line data, and a second area for receiving second line data as line unit data of the screen data stored in the first memory unit and for storing the second line data.

2. The image processing device according to claim 1, further comprising:
a screen processing unit that reads the first line data or the second line data stored in the third memory unit and performs screen processing for print image data based on the line data thus read out; and
a reference signal producing unit that produces a reference signal based on which third line data as line unit of the screen data stored in the first memory unit is written to the third memory unit in synchronization with reading of the first line data or the second line data.

3. An image forming method comprising:
transferring first screen data selected according to types of transfer medium inputted by a transfer medium information input unit from a second memory unit that stores a plurality of screen data to a first memory unit, and storing the selected first screen data;
transferring first line data as line image unit of the first screen data stored in the first memory unit to a first area of a third memory unit and storing the transferred first line data in the first area, and transferring second line data as line image unit of the first screen data stored in the first memory unit to a second area of a third memory unit and storing the transferred second line data in the second area; and
reading the first line data to perform screen processing for print image data.

4. The image forming method according to claim 3, further comprising:
reading the first line data to perform screen processing for print image data, and then reading the second line data to perform screen processing; and
writing third line data as line image unit of the screen data stored in the first memory unit to the third memory unit based on a reference signal produced in synchronization with reading of the second line data.

5. The image forming method according to claim 3, further comprising:
a rotational image carrying body;
an exposure head that includes an image forming system Having negative optical power and light emission element forming an image by using the image forming system and disposed in the rotational axis direction and rotational direction of the image carrying body; and
switching arrangement of image data to which screen processing has been applied based on the screen data in the rotational axis direction and rotation direction of the image carrying body after reading the first line data and performing screen processing for print image data.

6. An image forming apparatus comprising:
a rotational image carrying body;
an exposure head which includes an image forming system having negative optical power and light emission element forming an image by using the image forming system and disposed in the rotational axis direction and rotational direction of the image carrying body;
a first memory unit that stores screen data;
a screen processing unit that performs screen processing based on the screen data stored in the first memory unit; and
a control unit that switches arrangement of image data to which screen processing has been applied based on the screen data stored in the first memory unit in the rotational axis direction and rotation direction of the image carrying body.

7. The image forming apparatus according to claim 6, further comprising:
a developing unit that develops a latent image formed on the image carrying body by using the exposure head;
a transfer material to which the image developed on the image carrying body by the developing unit is transferred;
a transfer unit that transfers the image transferred on the transfer material to a recording medium; and
a recording medium information input unit that inputs information on the recording medium transferred by the transfer unit.

8. The image forming apparatus according to claim 7, Further comprising a second memory unit that stores first screen data associated with the type of the recording medium inputted to the recording medium information input unit, wherein:
second screen data stored in the second memory unit is transferred to the first memory unit to be stored therein; and
the screen processing unit performs screen processing based on the first screen data stored in the first memory unit.

9. The image forming apparatus according to claim 6, further comprising a third memory unit that writes line data as line image unit of the screen data stored in the first memory unit and reads the written line data.

10. The image forming apparatus according to claim 9, wherein the third memory unit has:
a first area to which first line data of the screen table is written; and
a second area to which second line data of the screen table is written,
and
the screen processing unit performs screen processing while reading the line data written to the first area, and
a reference signal producing unit produces a reference signal based on which third line data is written to the second area of the third memory unit in synchronization with the reading performed by the screen processing unit.

11. The image forming apparatus according to claim 8, wherein the second memory unit has a plurality of screen data according to types of recording medium.

12. The image forming apparatus according to claim 8, wherein the second memory unit has a plurality of screen data according to inputted attributes of print image data.

13. The image forming apparatus according to claim 8, wherein the second memory unit has a plurality of screen data corresponding to gradation values of inputted print image data.

14. The image forming apparatus according to claim 8, wherein:
the screen data stored in the second memory unit is selected according to information about recording medium inputted to the recording medium information input unit, attributes of the inputted print image data, and gradation values of the inputted print image data; and
the selected screen data is transferred to the first memory unit.
